(19) United States
(12) Patent Application Publication
(10) Pub. No.: US 2011/0058029 A1
(43) Pub. Date: Mar. 10, 2011

(54) EVALUATION METHOD OF TEMPLATE IMAGES AND IN VIVO MOTION DETECTING APPARATUS

(75) Inventors: Junko Nakajima, Tokyo (JP); Norihiko Utsunomiya, Machida-shi (JP)

(73) Assignee: CANON KABUSHIKI KAISHA, Tokyo (JP)

(21) Appl. No.: 12/874,909

(22) Filed: Sep. 2, 2010

(30) Foreign Application Priority Data
Sep. 10, 2009 (JP) 2009-209397

(51) Int. Cl. G06K 9/62; G06K 9/46; H04N 7/18; G06K 9/00

(52) U.S. Cl. 348/78; 382/209; 382/201; 382/128; 348/E07.085

(57) ABSTRACT

Multiple template images to be evaluated are used to carry out pattern matching with multiple images, correlation coefficients among the multiple template images are computed based on the results of the pattern matchings, and the template images are evaluated based on the computation result. As a result, the template images can be evaluated in the selection of template images used for pattern matching.

### BACKGROUND OF THE INVENTION

1. Field of the Invention

The present invention relates to an evaluation method of template images and an in vivo motion detecting apparatus, and particularly, to an evaluation method of template images and an in vivo motion detecting apparatus that evaluate template images in pattern matching of fundus images.

2. Description of the Related Art

In recent years, an ophthalmologic image represented by a fundus image is used in medical treatment as a medical image for early detection of disease. However, the influence of eye movement during the examination has been recognized for years as a big problem in the medical treatment using the ophthalmologic image. More specifically, the ophthalmologic image may be unclear due to the movement of eyes, and the accuracy of the examination and treatment may not be improved. Human eyes involuntarily repeat minute vibrations even when the eyes are fixated on one point. The patient cannot intentionally stop the involuntary eye movement. Therefore, measures need to be considered in the medical equipment or by the examiner/operator to eliminate the influence of the involuntary eye movement in the examination and treatment of the eyes.

Eliminating the involuntary eye movement without depending on the technique of the examiner/operator is important to perform high-quality medical treatment. Therefore, measures for the eye movement need to be taken in the medical equipment. For example, a tacking technique is disclosed as illustrated in Daniel X. Hammer, R. Daniel Ferguson, John C. Magill, and Michael A. White, “Image stabilization for scanning laser ophthalmoscopy”, OPTICS EXPRESS 10 (26), 1542-1549 (2002). In the technique, light for drawing a circle is directed to optic disc, and the eye movement is detected and corrected based on the displacement of the reflections.

However, in the technique of Daniel X. Hammer, R. Daniel Ferguson, John C. Magill, and Michael A. White, “Image stabilization for scanning laser ophthalmoscopy,” OPTICS EXPRESS 10 (26), 1542-1549 (2002), hardware for detecting the eye movement is needed in addition to the ophthalmoscope, which is cumbersome. Therefore, a tracking method that can be realized without additional hardware for detecting the eye movement is presented. A typical ophthalmoscope includes an apparatus that observes fundus for alignment, and in the method, the fundus observing apparatus detects a movement in a lateral direction of the fundus (direction perpendicular to the depth direction of the eyes) for tracking.

In that case, a distinguishing small region can be selected from the entire fundus images, and the movement of the small region among consecutive multiple fundus images can be detected to detect the movement of the entire fundus. According to the method, fewer calculations are necessary than in the detection of the movement of the entire fundus, and the movement of the fundus can be efficiently detected. The image of the distinguishing small region used at this point will be called a template image, and a technique called pattern matching is used to detect the movement of the template image. The pattern matching is a technique for finding a region that looks most like the template image from all target reference images.

In the detection of the movement of the fundus by the pattern matching using the template image, there may be a problem that the region does not match the region that should be detected or that the region matches with a region that should not be detected, depending on the selected template image. As a result, a false detection may be induced. Therefore, an appropriate selection of template images is important.

### SUMMARY OF THE INVENTION

However, conventionally, there is no appropriate method of evaluating template images, and better template images cannot be selected and set in the determination of the template image used in the pattern matching.

In view of the problem, an object of the present invention is to provide an evaluation method of template images capable of appropriately evaluating selected template images and an in vivo motion detecting apparatus based on the method.

A template evaluation method of the present invention is an evaluation method of template images used in pattern matching of images, the evaluation method comprising: a unit that uses each template image of a plurality of template images to apply pattern matching to a plurality of reference images; a unit that computes a correlation coefficient of a result of the pattern matching by the template image, for each combination of the template images; and a unit that evaluates each template image based on the computed correlation coefficient and that determines a template image having weak correlation with another template image as a poor template image.

The present invention provides an in vivo motion detecting apparatus comprising: an image acquiring unit that acquires in vivo images; a selecting unit that selects a plurality of template images from the images; a pattern matching unit that applies pattern matching to the plurality of in vivo images by the plurality of template images; a calculating unit that computes correlation coefficients among the plurality of template images based on results of the pattern matching; an evaluating unit that evaluates the template images based on results of the calculation; and a detection unit that uses template images evaluated to be good by the evaluating unit to perform pattern matching to quantitatively detect an in vivo motion.

According to the present invention, template images can be appropriately evaluated.

Further features of the present invention will become apparent from the following description of exemplary embodiments with reference to the attached drawings.

### BRIEF DESCRIPTION OF THE DRAWINGS

FIG. 1 is a flow chart of a process of the present invention in Example 1.

FIG. 2 is a hardware configuration diagram of Example 1.

FIG. 3 is a diagram illustrating a relationship between reference images and template images of the present invention.

FIGS. 4A, 4B, 4C, 4D, 4E and 4F are graphs illustrating correlations after the comparison of results of pattern matching among template images in Example 1.

FIG. 5 is a flow chart of step S102 in Example 2.

FIGS. 6A, 6B, 6C and 6D are schematic diagrams for describing steps 502 and 503 in Example 2.

FIG. 7 is a graph illustrating rates of misjudge based on the size of a central region of step 503 in the configuration of Example 2.

### DESCRIPTION OF THE EMBODIMENTS

Hereinafter, an embodiment of the present invention will be described in detail with reference to the drawings. Types, sizes, and shapes of images used in the present invention are not limited to the following configurations, and the present invention can be used to evaluate template images in pattern matching of any images. The present invention can be used to evaluate template images used in pattern matching of not only the fundus, but also of in vivo images of any regions.

### EXAMPLES

### Example 1

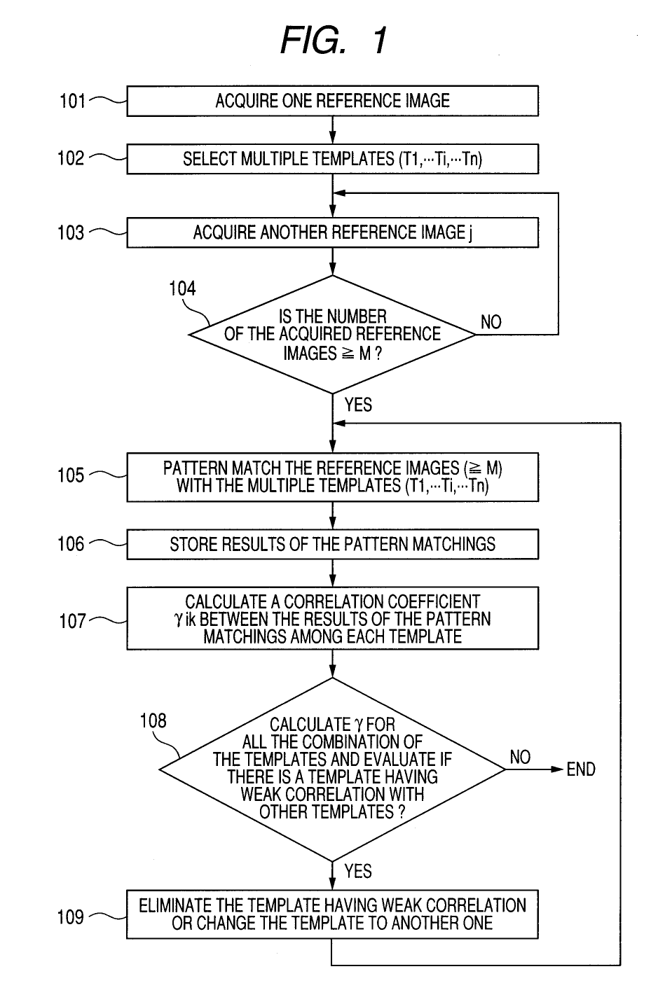

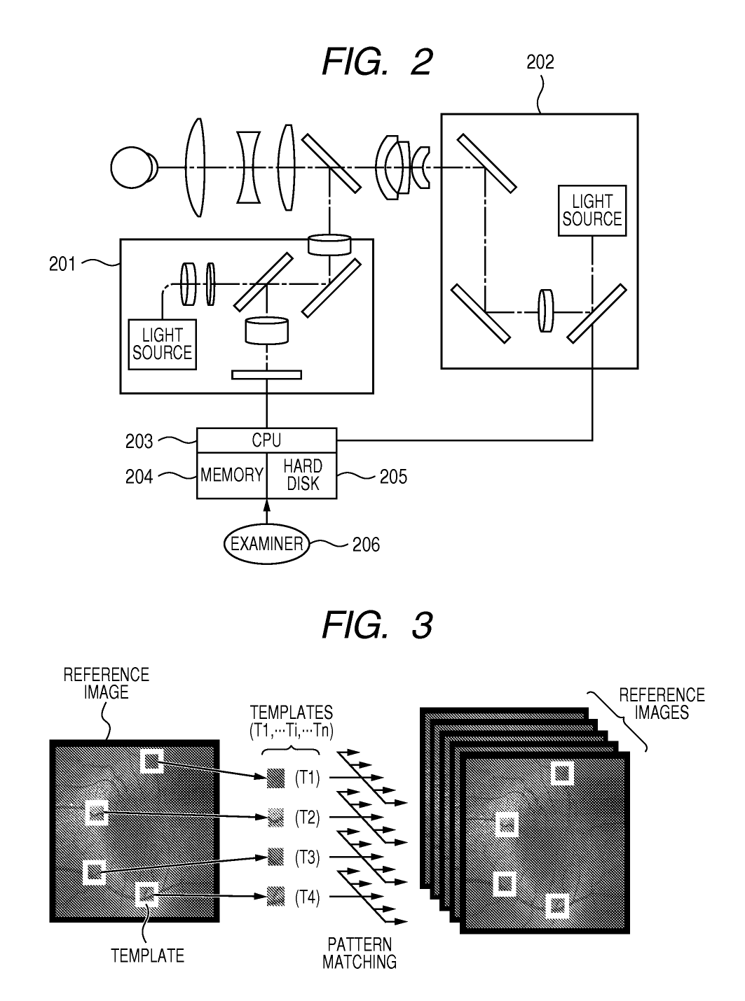

In Example 1, a method illustrating a flow chart of FIG. 1 for determining, evaluating, and selecting template images to acquire a good template image and a configuration of an in vivo motion detecting apparatus of FIG. 2 using the method will be described.

The in vivo motion detecting apparatus of FIG. 2 comprises an image acquiring unit of in vivo images including a scanning laser ophthalmoscope (hereinafter, “SLO”) 201 and an optical coherence tomography (hereinafter, “OCT”) 202, a CPU 203, a memory 204, and a hard disk 205. The SLO 201 and the OCT 202 can be realized by existing imaging systems, and the configurations are described simply. As described later, the CPU 203 functions as a selecting unit, a pattern matching unit, a calculating unit, an evaluating unit, and a detection unit by executing programs. With the configuration, the in vivo motion detecting apparatus of FIG. 2 can compare fundus images, which are obtained by photographing fundus by the SLO 201, in chronological order to detect eyeball movements, and at the same time, can prevent position misplacement in photographing of tomographic images by the OCT 202. Hereinafter, an SLO image denotes a fundus image taken by a scanning laser ophthalmoscope. A program for realizing the flow chart of FIG. 1 is stored in the hard disk 205, and the CPU 203 reads out and executes the program.

The process starts from step 101, “ACQUIRE ONE REFERENCE IMAGE,” of the flow chart of FIG. 1. The SLO 201 takes one SLO image in this step, and the image is saved in the memory 204. While the image used is not particularly limited, the image needs to have a size so large as to include a region where vessels are crossing or branching. In the present Example, an SLO image with a size of 2000×2000 pixels is used.

The process proceeds to step 102, “SELECT MULTIPLE TEMPLATES (T1, . . . Ti . . . , Tn).” The CPU 203 functions as a selecting unit and selects multiple template images from the SLO images saved in the memory 204 in step 101. The template images are images of distinguishing small regions that can be used in pattern matching. Step 101 may be skipped, and other template images saved in the memory 204 in advance may be selected in step 102. Examples of the distinguishing small region include, without limitation, optic disc and a region where vessels are crossing or branching. In the present Example, regions where vessels are crossing or branching are selected as distinguishing small regions, and are set as template images.

In the present Example, multiple template images are needed to evaluate the template images. It is desirable that the number of template images is three or more, however, depending on the case, the number of template images may be two. An examiner 206 can arbitrarily set the number of templates required for evaluation. In the present Example, the examiner 206 sets the number of template images to four or more, and the information is saved in the memory 204.

As illustrated in FIG. 3, four template images can be selected from four regions substantially symmetrically and substantially equally divided relative to the substantial center of the SLO image. The CPU 203 can also include a dividing unit that sets multiple regions substantially symmetrically and substantially equally divided relative to the substantial center of the fundus image. The CPU 203 can further include a selecting unit that selects multiple template images from the multiple regions. In this way, multiple template images are not selected only from a few local regions of the SLO image. Therefore, the movement caused by rotational eyeball motion can be accurately detected in addition to the movement caused by eyeball motion in X and Y directions. Furthermore, processes of selecting multiple template images from multiple regions can be executed in parallel. This can improve the speed of selecting the template images.

The method disclosed in Japanese Patent Application Laid-Open No. 2001-070247 can be used for the procedure of selecting the region where vessels are crossing or branching from the acquired reference image, or a method of Example 2 described below can be used. However, the method of selecting the distinguishing small region is not limited to these, and the template images may be selected by any known method.

After the process of extracting multiple template images, the CPU 203 proceeds to step 103. Step 103 is a step of acquiring multiple SLO images as reference images by use of the SLO 201 functioning as an image acquiring unit and of saving the images in the memory 204. The process of step 103 continues until the CPU 203 determines YES in the determination of step 104, “IS THE NUMBER OF THE ACQUIRED REFERENCE IMAGES ≧M?” The reference image acquired in step 101 may be included as one of the M reference images. The examiner 206 can arbitrarily set “M,” which is the number of reference images to be acquired. The number of the reference images to be acquired is not particularly limited as long as there are reference images enough to compute correlation coefficients described below. In the present Example, the examiner 206 sets the number of the reference images to be acquired to 20.

When M or more SLO images are acquired in the memory 204, the CPU 203 functions as a pattern matching unit and executes a process of step 105, “PATTERN MATCH THE REFERENCE IMAGES (≧M) WITH THE MULTIPLE TEMPLATES (T1, . . . Ti . . . , Tn)”. In this case, as illustrated in FIG. 3, the multiple template images (T1, . . . Ti . . . , Tn) acquired in step 102 are used, and the template images are used to separately pattern match all M or more reference images acquired in step 103.

At this point, when multiple regions that are substantially symmetrically and substantially equally divided relative to the substantial center of the fundus image are set and multiple template images are selected from the multiple regions, template matching can be performed for each of the divided multiple regions. In this way, multiple template matchings can be performed at the same time, and the processing time can be reduced.

The results of pattern matchings of the reference images by the template images are saved in the memory 204 for each of the used template images in step 106. As long as the correlation coefficients described below can be calculated, any information, such as information of position coordinates including X coordinates and Y coordinates of the detected region and the similarity with the template images, can be used for the results of pattern matchings. In the present Example, X coordinates of the regions detected in the reference images are used. The results may be saved in the memory during pattern matching or may be saved all together by computing information of detected positions after the termination of the pattern matching.

The process proceeds to step 107. The process of step 107 is a step in which the CPU 203 functions as a calculating unit and “calculates a correlation coefficient γik of Xij and Xkj (i≠k, j=1, . . . , M) among each template.” In this case, Xij denotes a result of pattern matching performed for a reference image j using a template image Ti, and as described, is an X coordinate in the reference image j of the detected region in the present Example. Similarly, Xkj denotes a result of pattern matching performed for the reference image j using a template image Tk and is an X coordinate in the reference image j of the detected region in the present Example. More specifically, the correlation of the results of pattern matching of the reference image j by two template images Ti and Tk is obtained based on pattern matching of M reference images j (j=1, . . . , M) in the step.

The CPU 203 uses the following formula to calculate the correlation coefficient γik of Xij and Xkj (i≠k, j=1, . . . , M).

$${γ}_{ik} = \frac{{\sum }_{j = 1}^{M} ( {x}_{ij} - {\overline{x}}_{i} ) ( {x}_{kj} - {\overline{x}}_{k} )}{\sqrt{{\sum }_{j = 1}^{M} {( {x}_{ij} - {\overline{x}}_{i} )}^{2}} \sqrt{{\sum }_{j = 1}^{M} {( {x}_{kj} - {\overline{x}}_{k} )}^{2}}} \qquad Expression 1$$

Here, X̅ denotes arithmetic means of Xi1 to XiM, and X̅ denotes arithmetic means of Xk1 to XkM.

The correlation coefficient γik denotes a correlation between results of applying pattern matching to the M reference images by the template image Ti and results of applying pattern matching to the M reference images by the template image Tk. In the present Example, the CPU 203 performs the calculation for all combinations among the template images (T1, . . . Ti . . . , M), obtains each correlation coefficient, and stores the coefficients in the memory 204. However, the correlation coefficients may not be obtained from all combinations, as long as the number of the computed correlation coefficients at least fulfills the number of combinations capable of determining, for all template images, whether the correlations with other templates are weak in the following step 108.

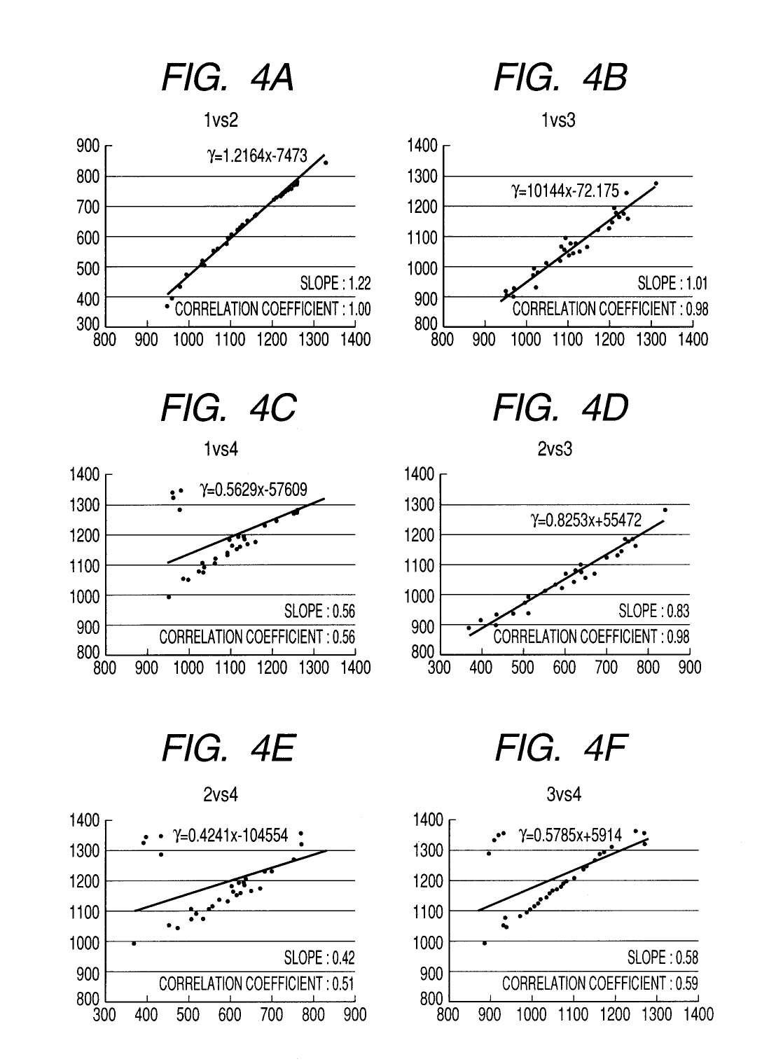

FIGS. 4A, 4B, 4C, 4D, 4E and 4F illustrate correlations of the results of pattern matching of 20 reference images using template images T1 to T4 in the present Example, for each combination of the template images. In FIGS. 4A, 4B, 4C, 4D, 4E and 4F, X coordinates (in pixels) of the detected regions as results of pattern matching of M reference images are compared for each combination of the template images, and the correlation coefficients are obtained. For example, FIG. 4A is a graph, in which values of X coordinates of the results of pattern matching of the reference image j by the template T1 are set as values in the X axis direction, and values of X coordinates of the results of pattern matching of the same reference image j by the template T2 are set as values in the Y axis direction to plot points. Points for M reference images are similarly plotted to obtain the correlation coefficient. Similarly, in FIGS. 4B, 4C, 4D, 4E and 4F, the results by one of the template images are set as the values in the X axis direction, and the results by the other template images are set as the values in the Y axis direction to obtain correlation coefficients.

The process proceeds to step 108. Step 108 is a step in which the CPU 203 functions as an evaluating unit and “CALCULATES γ FOR ALL THE COMBINATION OF THE TEMPLATES AND EVALUATES IF THERE IS A TEMPLATE HAVING WEAK CORRELATION WITH OTHER TEMPLATES.” In the present Example, the results of pattern matching indicate positive correlations. The maximum value of the correlation coefficient is 1. The correlation between template images is stronger if the correlation coefficient is closer to 1. The correlation between template images is weaker if the correlation coefficient is closer to 0. The template images are completely correlated if the correlation coefficient is 1. In the present Example, the possibility that the same region is detected for the two compared template images is high in any reference image if the correlation coefficient is closer to 1, and the reliability of the two template images is high. On the other hand, the result of the pattern matching by the two template images is unstable if the correlation coefficient is closer to 0, and one or both of the used template images tend to detect wrong regions. A template having weak correlation with multiple templates is determined in the present step as a poor template that induces false detection.

The examiner 206 determines a threshold with a value from 0 to 1 and saves the threshold in the memory 204 in advance, and the CPU 203 as an evaluating unit determines that the correlation is strong if the correlation coefficient is equal to or greater than the threshold in step 108. More specifically, for the combination of the template images Ti and Tk, the CPU 203 as an evaluating unit does not save anything in the memory 204 if γik is equal to or greater than the threshold. On the other hand, the CPU 203 as an evaluating unit determines that one of the template images Ti and Tk is a poor template image if γik is smaller than the threshold and saves Ti and Tj in the memory 204 as candidates for poor template images. The CPU 203 as an evaluating unit checks all correlation coefficients calculated in step 107, determines whether the template images are candidates for poor images, and saves that the template images are candidates for the poor images if the template images are candidates for the poor images. In the present Example, correlation with 0.7 or more correlation coefficient is defined as a strong correlation. Therefore, the correlations are determined to be strong for the combinations among T1 to T3 (FIGS. 4A, 4B and 4D). On the other hand, the correlations are determined to be weak for the combinations of each of T1 to T3 and T4 (FIGS. 4C, 4E and 4F). Therefore, T1 to T3 are saved in the memory 204 as candidates for poor template images once for each, and T4 is saved three times.

After checking all correlations, the CPU 203 as an evaluating unit determines whether the template images are good images or poor images based on the results saved in the memory 204. The examiner 206 can arbitrarily set the standard for determining that the template image is poor. In the present Example, the CPU 203 as an evaluating unit saves the template images, which are determined to have weak correlations with multiple template images, as poor template images in the memory 204. The CPU 203 saves the template images other than the images determined to be poor template images as good template images in the memory 204. Therefore, the CPU 203 saves T4 having weak correlation with T1 to T3 as a poor template image in the memory 204 and saves T1 to T3 as good template images in the memory 204.

The standard for the determination is not limited to the method. For example, the template images may be scored based on the correlation coefficients, and whether the correlation with other template images is good or poor may be calculated based on an average value of the scores. If two templates are used and the correlation between the two templates is weaker than the threshold predetermined by the examiner 206, the two templates may be stored as poor templates, and the templates may be saved as good images in other cases.

The process ends if all template images are determined to be good template images. The CPU 203 then functions as a detection unit and uses the good template images saved in the memory 204 to perform pattern matching. The CPU 203 can quantitatively detect in vivo motion, such as eyeball motion, and can prevent position displacement during photographing of a tomographic image.

If there is even one template image determined to be poor by the CPU 203, the process proceeds to step 109.

Step 109 is a process “ELIMINATE THE TEMPLATE HAVING WEAK CORRELATION OR CHANGE THE TEMPLATE TO ANOTHER ONE.”

The CPU 203 deletes the information of the template image determined to be poor from the memory 204. In the present Example, the template 4 is deleted based on the result.

The examiner 206 saves the ultimately necessary number of template images in the memory 204 in advance. The process ends if the number of template images remaining as a result of step 109 is greater than the number of necessary template images. The CPU 203 then functions as a detection unit and uses the good template images saved in the memory 204 to perform pattern matching. The CPU 203 can quantitatively detect in vivo motion, such as eyeball motion, and can prevent position displacement during photographing of a tomographic image. On the other hand, if the number of remaining template images is smaller than the number of necessary template images, the template image to be used is changed to another one, and the process after step 105 is repeated. In this case, another template image may be acquired from the images from which the template images are selected in step 102, or the template image may be prepared from the reference image acquired in step 103 or from other images.

The CPU 203 repeats 105 to 109 of the flow chart of FIG. 1 until good template images are gathered up to the number of necessary template images. The process ends if the CPU 203 determines that the good template images are gathered.

As described, the acquired template images can be appropriately evaluated, and the necessary number of good template images can be acquired.

Subsequently, in the present Example, the SLO 201 takes fundus images, and the CPU 203 as a detection unit uses the selected template images to pattern match the SLO images aligned in chronological order to quantitatively detect the eyeball movement. The detected eyeball motion can also be used to correct the displacement, which is caused by the eyeball motion, of the fundus images photographed by the OCT 202 at the same time.

According to such a configuration, the eyeball motion can be quantitatively detected and corrected without installing hardware for detecting the movement, and the unclarity of the acquired images can be prevented.

In the present Example, multiple templates selected in step 102 are used to template match the multiple reference images acquired in step 103. However, another template may be selected from the reference images acquired in step 103, and the template image may be matched with the template images selected in step 102. In this case, if one or multiple template images are selected from four regions substantially symmetrically and substantially equally divided relative to the substantial center of the SLO image in step 102, template images corresponding to the template images selected in step 202 in the reference images acquired in step 203 may be selected, or other template images may be acquired from four regions substantially symmetrically and substantially equally divided relative to the substantial center of the SLO image in the reference images acquired in step 203 to match the template image with the template images selected in step 202. Since the reference images acquired in step 103 and the reference images acquired in step 101 are acquired at different times, the eyeball movement during that time can be taken into consideration to surely evaluate the templates.

### Example 2

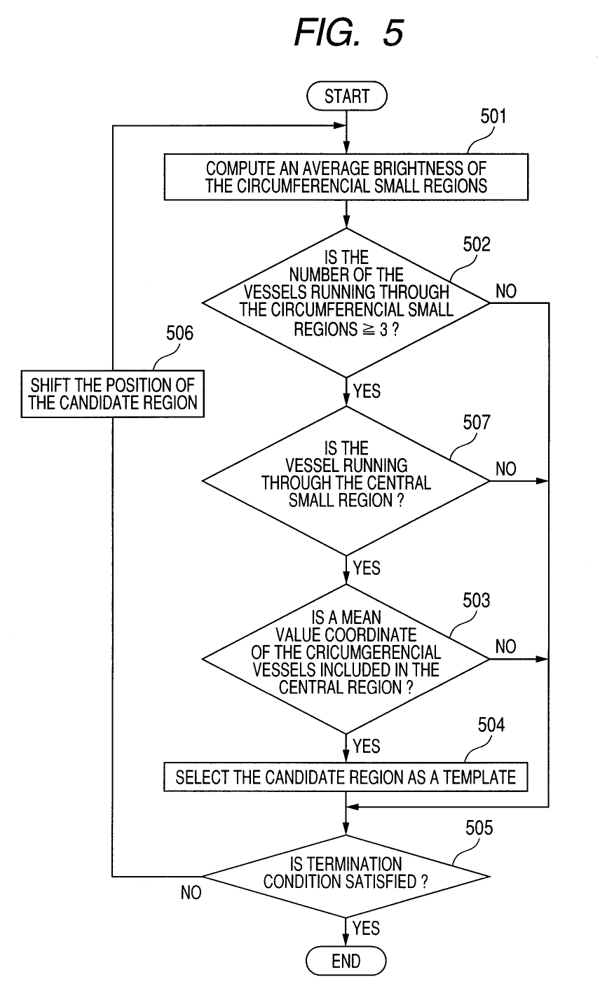

Example 2 illustrates an example of a process of selecting a region where vessels are crossing or branching in the present Example in accordance with a flow chart of FIG. 5 in the acquisition of multiple template images from reference images in step 102 of Example 1. In the present Example, the region where vessels are crossing or branching can be more surely selected, and the template image can be selected so that the region where vessels are crossing or branching is more surely positioned at the center of the selected template image.

Example 2 is the same as Example 1 other than the used reference images and step 102, and the overlapping parts will not be described.

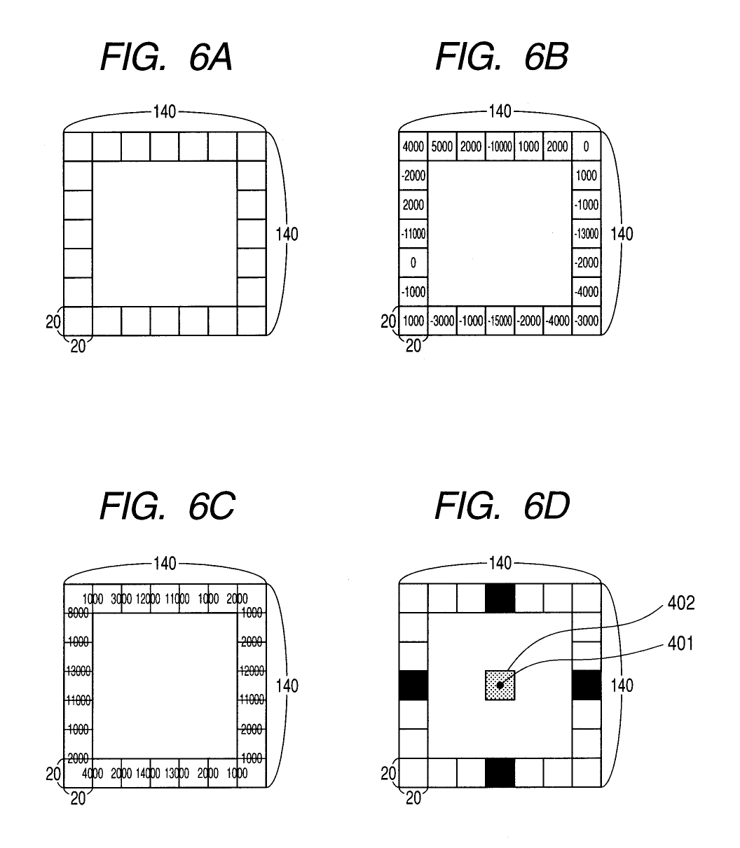

The CPU 203 first starts the process by selecting a small region at the upper left corner of the SLO image as a candidate region for selecting templates and by saving the image of the small region in the memory 204. The examiner 206 determines the size of the candidate region for selecting templates in advance and saves the size in the memory 204. The size of the candidate region for selecting templates is not particularly limited, as long as the region where vessels are crossing or branching can be included. As illustrated in FIG. 6A, the size is 140×140 pixels in the present Example. This is the smallest size without false detection in pattern matching when the present inventor uses the present invention to select the region where vessels are crossing or branching and to pattern match the SLO image taken from the same subject with the selected region serving as the template image. The shape of the candidate region for selecting templates is not limited to square, and the region can have any shape, such as rectangle and circle.

Step 501 of the flow chart of FIG. 5 will be described. Step 501 is a step in which the CPU 203 determines circumferential small regions of the selected candidate region for selecting templates, calculates an average value of brightness of pixels included in each of the circumferential small regions, and saves the average value in the memory 204. The CPU 203 first sets square regions aligned along circumference of the candidate region for selecting templates without spaces, in accordance with the size of the circumferential small regions designated by the examiner 904. The square regions set along the circumference will be called circumferential small regions. The shape of the circumferential small regions is not limited to square, and the regions can have any shape as long as the regions can be set aligned along the circumference of the candidate region for selecting templates. However, the size in the width direction of the circumferential small regions relative to the circumference of the candidate region for selecting templates needs to be about the same size as the thickness of the vessel. The thickness of the vessel is about 20 pixels in the image of the present Example, and the examiner 206 determines the size of the circumferential small regions to be 20×20 pixels and inputs the size from an input apparatus not shown to save the size in the memory 204.

FIG. 6A illustrates the candidate regions for selecting templates selected by the CPU 203. The size of the candidate region for selecting templates is 140×140 pixels, and 24 circumferential small regions with 20×20 pixels are set as circumferential regions.

The CPU 203 averages the brightness values of all pixels included in each circumferential small region and saves the values in the memory 204 as values representing the circumferential small regions. FIG. 6B illustrates a diagram of the concept.

Step 502 is a step in which the CPU 203 determines whether the vessels run through three or more parts of the circumferential small regions.

The CPU 203 first obtains absolute values of differences in brightness average values between adjacent circumferential small regions and save the absolute values in the memory 204. FIG. 6C illustrates a diagram of the concept. Subsequently, if the absolute value of the difference in the brightness average values between adjacent circumferential small regions is equal to or greater than a first threshold A and the brightness of the adjacent circumferential small regions with lower brightness average value is equal to or smaller than a second threshold B, the CPU 203 determines that a vessel runs through the circumferential small region indicated by the lower brightness average value.

An examiner 904 can arbitrarily determine the first threshold A and the second threshold B. In the present Example, the examiner 206 determines that the first threshold A is 8000 and the second threshold B is −10000. Therefore, based on FIGS. 6B and 6C, the circumferential small regions painted in black in FIG. 6D are determined as the circumferential small regions in which the vessels run through.

A CPU 902 then determines whether there are three or more circumferential small regions in which the vessels run through. If the CPU 902 determines that there are three or more circumferential small regions in which the vessels run through, the CPU 203 proceeds to step 507. If there are less than three circumferential small regions, the CPU 203 proceeds to a process of step 505.

Step 507 is a step in which the CPU 203 determines whether a vessel runs through a central small region of the candidate region for selecting templates. The central small region is a square region having the same center of gravity as the candidate region for selecting templates. Although the examiner 904 can arbitrarily determine the size of the central small region, it is desirable that the width is about the same as the thickness of the vessel. As described, since the thickness of the vessel is about 20 pixels in the Example, the examiner 206 determines the size of the central small region to be 20×20 pixels and saves the size in the memory.

The CPU 203 determines whether the vessel runs through the central small region of the candidate region for selecting templates as follows. The CPU 203 first averages the brightness of the pixels of the central small region and obtains an average value. The CPU 203 determines that the vessel runs through the central small region if the average value is equal to or smaller than a threshold D saved in advance in the memory by the examiner 206.

The examiner 206 can arbitrarily determine the threshold D. In the present example, the examiner 206 sets the threshold D to −10000, which is equal to the threshold B used to determine whether there are vessels in the circumferential small regions. The process proceeds to step 503 of the flow chart of FIG. 5 if the CPU 203 determines that the vessel runs through the central small region. If the CPU 203 does not determine that the vessel runs through the central small region, the candidate region for selecting templates is shifted (step 506), and the process returns to step 501.

Step 503 is a step in which the CPU 902 determines whether a mean value coordinate of a circumferential vessels is in a range of a central region.

In the present Example, the circumferential vessel is the circumferential small region for which the CPU 902 has determined that the vessel runs through in step 502. If two vessels exist in the candidate region for selecting template and the two vessels intersect one another, the center of the intersection of the vessels can be at the position (mean value coordinate) where the coordinates of the circumferential vessels are averaged. Therefore, the possibility that the intersection exists in the central region of the selected image increases by selecting and extracting the candidate region for selecting templates in which the mean value coordinate is in the central region of the candidate region for selecting templates.

The CPU 902 uses coordinate positions of multiple circumferential small regions where the circumferential vessel runs through in the candidate region for selecting templates and obtains positional coordinates of the center of gravity of the circumferential vessel. More specifically, the positional coordinate values of all circumferential small regions where the circumferential vessel runs through are added for the X axis and the Y axis, and the sums are divided by the number of circumferential small regions where the circumferential vessel runs through to obtain the mean value coordinate of the circumferential vessels.

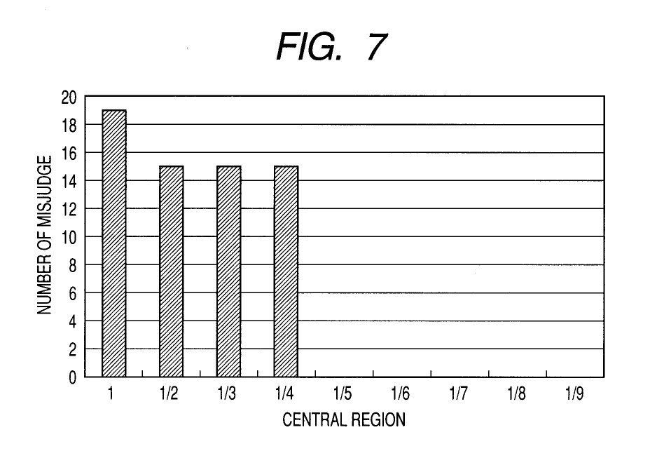

In the present Example, the central region is a square region having the same center of gravity as the candidate region for selecting templates, having a predetermined area, and existing in the candidate region for selecting templates. Although the area of the central region can be arbitrarily determined, the area can have the size in which the length of one side is equal to or smaller than one fifth (equal to or greater than one ninth) of the candidate region for selecting templates (region accounting for 1/25 or less and 1/81 or more of the area of the entire candidate region for selecting templates) to ameliorate misjudge (FIG. 7).

The horizontal axis of FIG. 7 illustrates the size of the central region relative to the candidate region for selecting templates when the length of one side of the candidate region for selecting template is 1, by the ratio of the length of one side of each of the squares. For example, when the size of the central region illustrated in the horizontal axis is ½, each side of the square of the central region is ½ of the candidate region for selecting templates. Therefore, the central region is a region accounting for ¼ of the area of the candidate region for selecting templates. The vertical axis of FIG. 7 denotes the number of the candidate regions for selecting templates in which regions where vessels are crossing or branching are not recognized by visual observation (misjudge) among the candidate regions for selecting templates selected as the regions where vessels are crossing or branching from equal SLO images in the candidate regions for selecting templates with various sizes. If the ratio of the length of one side is 1, the entire candidate regions for selecting templates are assumed as the central regions. As a result, step 503 is entirely Yes, and all candidate regions for selecting templates are selected as the regions where vessels are crossing or branching in step 404. In other words, when the ratio of the length of one side of the central region is 1, the result is equivalent to that of the conventional technique (Japanese Patent Application Laid-Open No. 2001-070247). It can be recognized from FIG. 7 that the number of misjudges is smaller in the present Example than that in the conventional technique if the size of the central region is smaller and that the accuracy of the determination has improved. In the present Example, the examiner 206 determines that the length of one side of the central region is one seventh of the candidate region for selecting templates.

If the average coordinate of the circumferential vessels is included in the area of the central region, the CPU 902 proceeds to a process of step 504 and selects the candidate region for selecting templates as the region where vessels are crossing or branching. If the average coordinate of the circumferential vessels is not included in the area of the central region, the CPU 902 does not determine that the region where vessels are crossing or branching exists in the candidate region for selecting templates and does not select the candidate region for selecting templates. In this case, the CPU 902 proceeds to step 505.

As described, in the present Example, it is determined that the circumferential vessels are distributed as in FIG. 6D, and the mean value coordinate 401 of the circumferential vessels is included in the area of a central region 402 of the candidate region for selecting templates. Therefore, the CPU 902 determines yes in step 503 and selects the candidate region for selecting templates as a region including the region where vessels are crossing or branching in the following step 504.

The CPU 203 then proceeds to step 505. Step 505 is a step in which the CPU 203 determines whether a termination condition is satisfied. The examiner can arbitrarily determine the termination condition. In the present Example, “whether all fundus images are scanned” is the termination condition. When the CPU 902 determines that the current status does not satisfy the termination condition, the CPU 902 shifts the candidate region for selecting templates (step 506) and returns to the process of step 501. The examiner 206 can arbitrarily determine the number of pixels to be shifted. In the present Example, the candidate region for selecting templates is shifted pixel by pixel to the right on the image. When the region reaches the right end of the image, the region is shifted pixel by pixel downward to return to the left end of the image, and the process returns again to step 501.

The CPU 203 repeats the determination and the process from steps 501 to 505 while shifting the candidate region for selecting templates (step 506) to scan the fundus image until the CPU 203 determines that the termination condition (“whether all fundus images are scanned” in the present Example) is satisfied. The process ends when the CPU 203 determines that the termination condition is satisfied (scanning of all fundus images is finished in the present Example).

If the number of template images selected in step 504 does not satisfy the number necessary for evaluation, the region closest to the condition may be saved in the memory 204 after the determination of No in step 503 to select the region, or the process may be carried out again from the beginning after easing the condition.

According to the method of the present Example, the template images can be efficiently acquired. Furthermore, since the region where vessels are crossing or branching is surely positioned in the central region of the acquired template image, the evaluation of template in Example 1 can be more surely and efficiently performed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-209397, filed on Sep. 10, 2009, which is hereby incorporated by reference herein in its entirety.

What is claimed is:

1. An evaluation method of template images used in pattern matching of images, the evaluation method comprising:
using each template image of a plurality of template images to apply pattern matching to a plurality of reference images;
computing a correlation coefficient of a result of the pattern matching by the template image, for each combination of the template images; and
evaluating each template image based on the computed correlation coefficient and determining a template image having weak correlation with another template image as a poor template image.

2. The evaluation method of template images according to claim 1, wherein
the template image is selected from one of the plurality of reference images applied with the pattern matching.

3. The evaluation method of template images according to claim 1, wherein
the images are in vivo images.

4. The evaluation method of template images according to claim 1, wherein
positional coordinates of a region detected in the pattern matching are used as a result of the pattern matching used to compute the correlation coefficient.

5. The evaluation method of template images according to claim 1, wherein
the evaluation of the template image in the combination is better if the correlation coefficient is closer to 1.

6. An in vivo motion detecting apparatus comprising:
an image acquiring unit that acquires in vivo images;
a selecting unit that selects a plurality of template images from the images;
a pattern matching unit that applies pattern matching to plurality of the in vivo images by the plurality of template images;
a calculating unit that computes correlation coefficients among the plurality of template images based on results of the pattern matching;
an evaluating unit that evaluates the template images based on results of the calculation; and
a detection unit that uses template images evaluated to be good by the evaluating unit to perform pattern matching to quantitatively detect an in vivo motion.

7. A program causing a computer to execute the evaluation method of template images according to claim 1.

8. An ophthalmologic imaging apparatus comprising:
an image acquiring unit that acquires a fundus image;
a dividing unit that sets a plurality of regions substantially symmetrically and substantially equally divided relative to the substantial center of the fundus image; and
a selecting unit that selects a plurality of template images from each of the plurality of regions.

9. The ophthalmologic imaging apparatus according to claim 8, wherein
the image acquiring unit acquires a first fundus image and a second fundus image acquired at a different time from the first fundus image,
the selecting unit selects the plurality of template images from each of the first and second fundus images, and
the plurality of template images acquired from each of the first and second fundus images are matched in each of the plurality of regions.

10. An ophthalmologic imaging method comprising:
acquiring a first fundus image;
selecting a plurality of template images from each of a plurality of regions substantially symmetrically and substantially equally divided relative to the substantial center of the first fundus image;
acquiring a second fundus image acquired at a different time from the first fundus image;
selecting a plurality of template images from the plurality of regions in the second fundus image that are corresponding to the plurality of regions in the first fundus image; and
matching each of the plurality of template images selected from the first and second fundus images in each of the plurality of regions.

11. An ophthalmologic imaging apparatus comprising:
an image acquiring unit that acquires a fundus image; and
a selecting unit that selects a plurality of template images from each of a plurality of regions substantially symmetrically and substantially equally divided relative to the substantial center of the fundus image.

12. An ophthalmologic imaging method comprising:
acquiring a fundus image
selecting a plurality of template images from each of a plurality of regions substantially symmetrically and substantially equally divided relative to the substantial center of the fundus image.
